(19) United States
(12) Patent Application Publication
(10) Pub. No.: US 2026/0161799 A1
(43) Pub. Date: Jun. 11, 2026

(54) USER INTERFACE FOR CONVERTING SEARCH RESULTS OF DOMAIN-LEVEL CLOUD CONTENT ITEMS INTO SECURITY RULE

(71) Applicant: Material Security Inc., San Francisco, CA (US)

(72) Inventors: John Glenn Hrvatin, Valley Village, CA (US); Gianluca Venturini, San Francisco, CA (US); Melissa Anne Skevington, San Francisco, CA (US)

(21) Appl. No.: 19/182,297

(22) Filed: Apr. 17, 2025

Related U.S. Application Data
(60) Provisional application No. 63/636,051, filed on Apr. 18, 2024.

(51) Int. Cl. G06F 21/57; G06F 16/34

(52) U.S. Cl. CPC G06F 21/577; G06F 16/34

(57) ABSTRACT

A system generates a test interface for display at a client device. The test interface includes an input field for matching criteria. The system receives input of matching criteria from an administrator of a domain associated with the client device. The system searches for files within a content management system repository corresponding to the domain having content that matches the matching criteria. The system updates the representations as the matching criteria is edited. The system receives user input to form a rule based on the matching criteria and monitors for files satisfying the rule. The monitoring may result in a remediation action for files that satisfy the rule.

### CROSS REFERENCE TO RELATED APPLICATIONS

This application claims the benefit of priority to U.S. Provisional Application No.: 63/636,051, filed on Apr. 18, 2024, which is incorporated herein by reference for all purposes.

### TECHNICAL FIELD

The disclosure generally relates to the field of security for electronic files, and more particularly relates to an improved user interface for building security rules for files using a search feature.

### BACKGROUND

Cloud-based content management systems such as GOOGLE DRIVE and DROPBOX have become ubiquitous for storing files for domains (e.g., companies have persons store files such as individual or collaborative documents on the content management system). Cloud storage of files comes with myriad security risks to a domain, such as accidental exposure of confidential information to the public, ease of absconding with confidential information by a bad actor, access of private information being permissioned to the wrong parties, and so on. Where administrators seek to prevent exposure of sensitive information, administrators may define broad categories where actions should be taken (e.g., alert the administrator where private identifying information (PII) is being exposed). However, there is no sandbox to test the category settings, resulting in false positives and wrong narrower categories being detected against an intent of the administrator. This results in wasted computation and bandwidth consumption generating alerts and running checks on files that are not within the scope of what the administrator is actually looking for, and results in wasted computational capacity on many re-done attempts from scratch in building new category settings until a satisfactory setting is achieved, if possible from the limited options available.

### SUMMARY

Systems and methods are disclosed herein for providing an improved user interface that allows an administrator to sandbox, test, and refine security rule settings before establishing security rules to perform remediations for files at risk of security violations. In an embodiment, metadata and/or content of files stored for a domain on a content management system are aggregated in a security repository. A security service receives a search from an administrator for files and, in a search interface, offers refinement tools and rule setting tools. The search interface offers an ability to save search parameters as a rule. The search interface enables automatic remediations (e.g., alerts, quarantine, etc.) for matching files on an ongoing basis where files come to match the search criteria. By monitoring for files and storing the files in a single secure repository, the security service enables a global search across the domain of the content management system.

The systems and methods disclosed herein are also for quarantining files that violate one or more custom security rules. In an embodiment, a security service monitors metadata and/or content of files aggregated in a security repository for files that violate one or more quarantine rules. The security system updates a permissions data structure to reflect changes in direct permissions allocated for files that violate the one or more quarantine rules. The security system moves the file to a quarantine storage repository before revoking inherited permissions to the files in the permissions data structure. By changing permissions to files in this structured manner, the security service may effectively prevent access to the files while in quarantine and maintain the ability to reinstate the permissions after quarantine.

In accordance with one or more embodiments, a system generates a test interface for display at a client device. The test interface includes an input field for matching criteria. The system receives input of matching criteria from an administrator of a domain associated with the client device. The system searches for files within a content management system repository corresponding to the domain having content that matches the matching criteria. The system updates the representations as the matching criteria is edited. The system receives user input to form a rule based on the matching criteria and monitors for files satisfying the rule. The monitoring may result in a remediation action for files that satisfy the rule.

In accordance with one or more embodiments, a system determines whether a file stored in cloud storage in association with a domain satisfies a quarantine rule. The system makes the determination based on metadata associated with the file that is stored in a content management system repository corresponding to the domain. In response to determining that the file that satisfies the quarantine rule, the system updates a permissions data structure to provide direct permission to an administrator to access the file. The administrator has access to files stored within a quarantine storage repository for the domain. The system also updates the permissions data structure to revoke existing direct permission to access the file for a first set of users. A second set of users retain inherited permission to access the file based on being permissioned to access one or more files, including the file, in a given cloud storage location. The system moves the file to the quarantine storage repository. In response to moving the file to the quarantine storage repository, the system revokes the inherited permissions to access the file from each of the second set of users.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates one embodiment of a system environment including infrastructure for a secure communications service to enforce security rules on files stored within a cloud-based content management system, in accordance with one or more embodiments.

FIG. 2 is a block diagram of a secure communications service, in accordance with one or more embodiments.

FIGS. 3A-3F illustrate exemplary user interfaces that are used by administrators operating a secure communications service to secure cloud-stored files of a domain, in accordance with one or more embodiments.

FIG. 4 is a block diagram illustrating components of an example machine able to read instructions from a machine-readable medium and execute them in a processor (or controller), in accordance with one or more embodiments.

FIG. 5 is a flowchart of a method for monitoring for files that satisfy a rule, in accordance with one or more embodiments.

FIG. 6 is a flowchart of a method for quarantining a file, in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

FIG. 1 illustrates one embodiment of a system environment including infrastructure for a secure communications service to enforce security rules on files stored within a cloud-based content management system. As depicted in FIG. 1, environment 100 includes domain 110, network 120, secure communications service 130, and content management system 140. Domain 110 may be any environment having a plurality of users sharing a common set of security constraints. A typical domain may include users within a company sharing a domain name and sharing a team of administrators, such as an information technology team. Domain 110 includes user 111 and administrator 112. While these are recited in the singular, any number of users and administrators may be part of domain 110.

User 111 may be any user operating under the security policies provided by administrator 112. User 111 may include different users subject to different security policies (e.g., different teams within a domain may be subject to different security policies; users with certain titles may be subject to different security policies; etc.). User 111 may connect to domain 110 through any client device, such as a laptop, personal computer, smartphone, smart watch, or any other client device having a user interface capable of interfacing with domain 110.

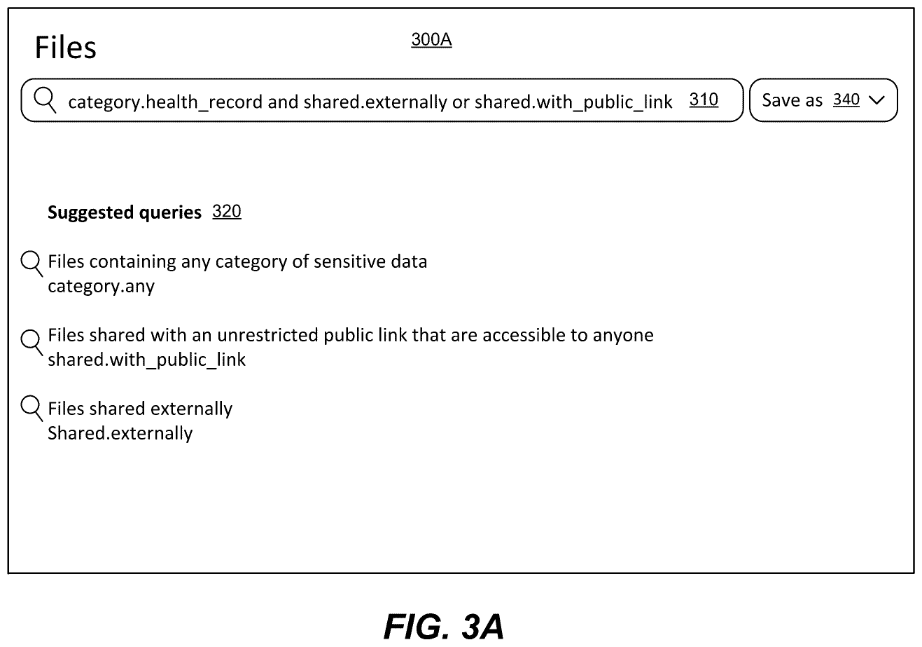

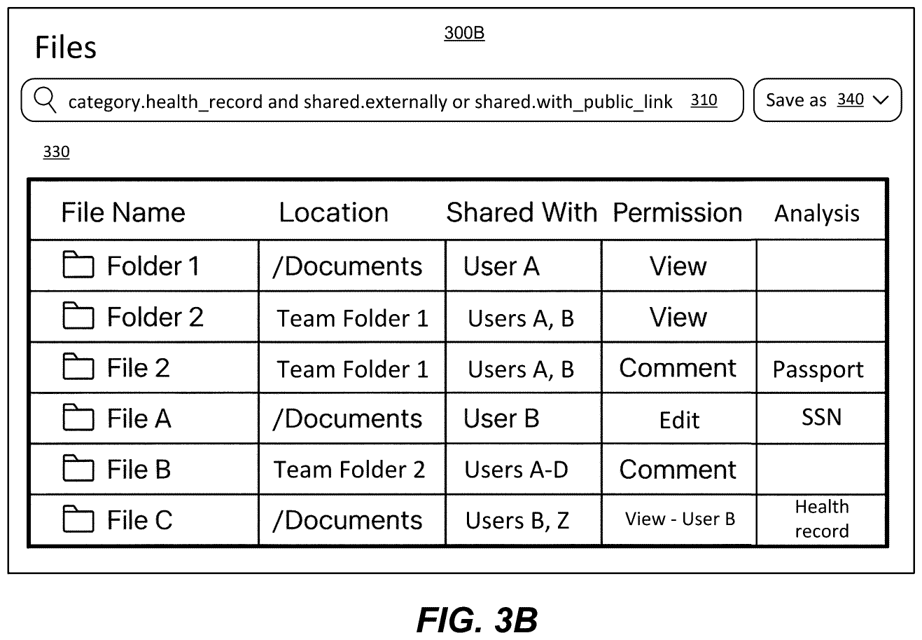

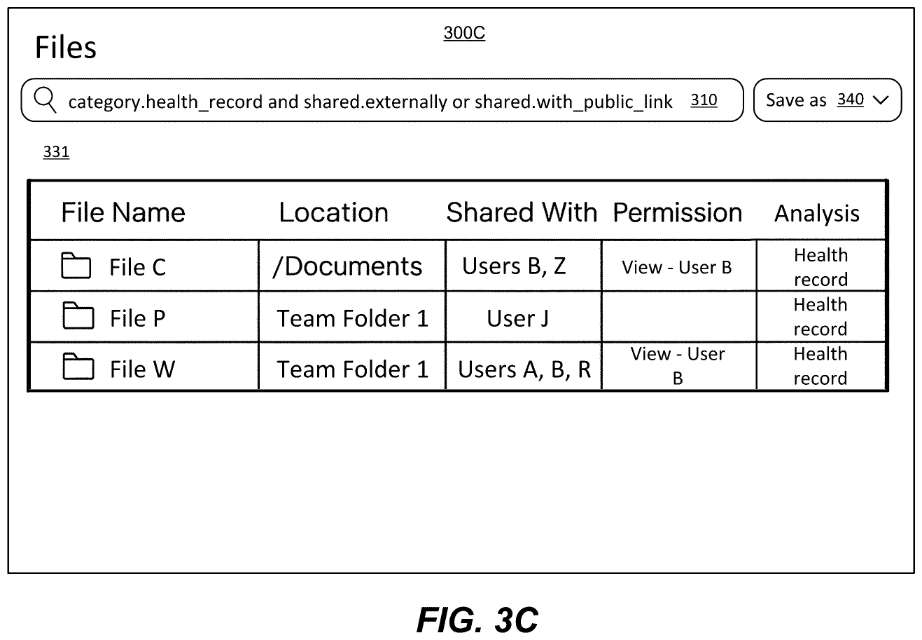

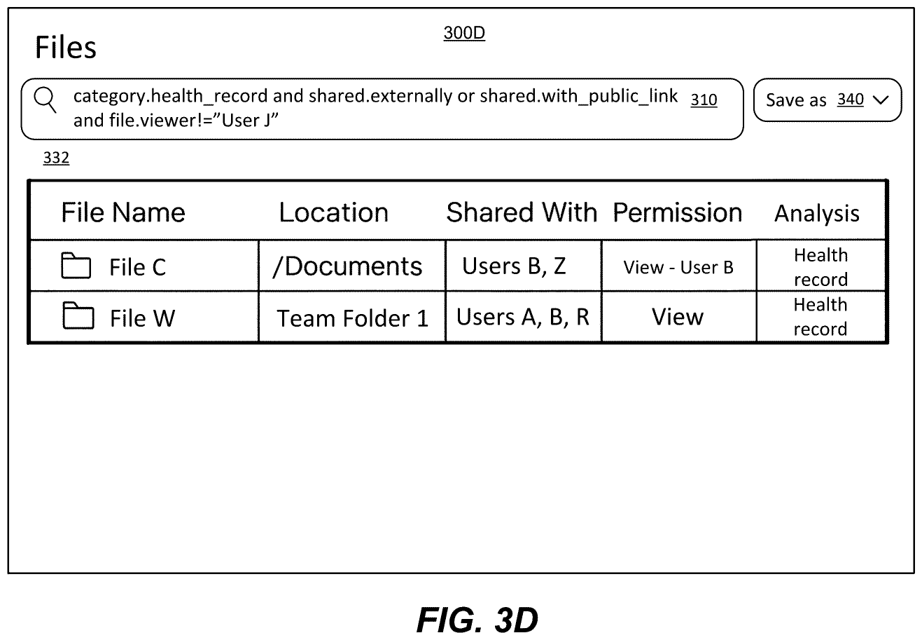

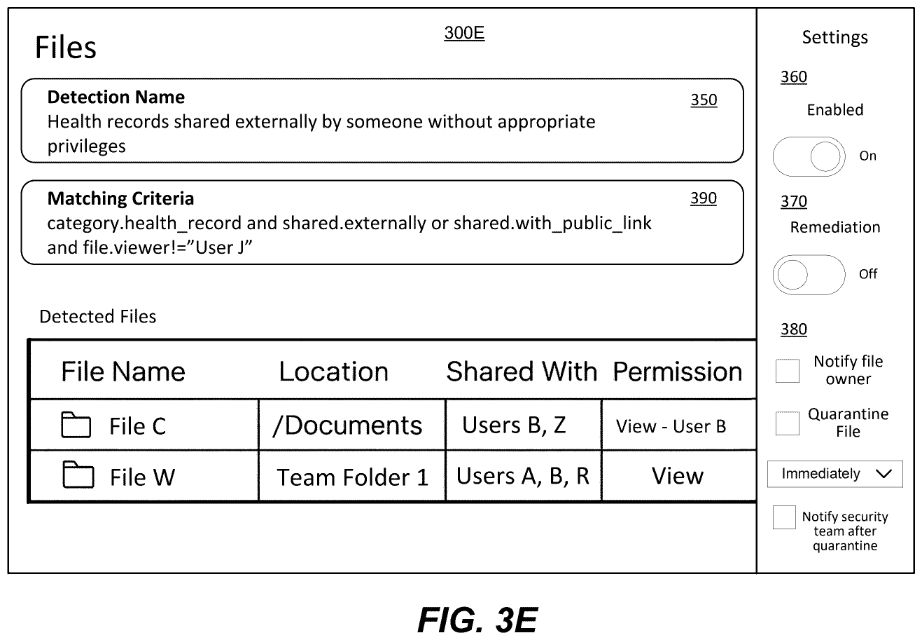

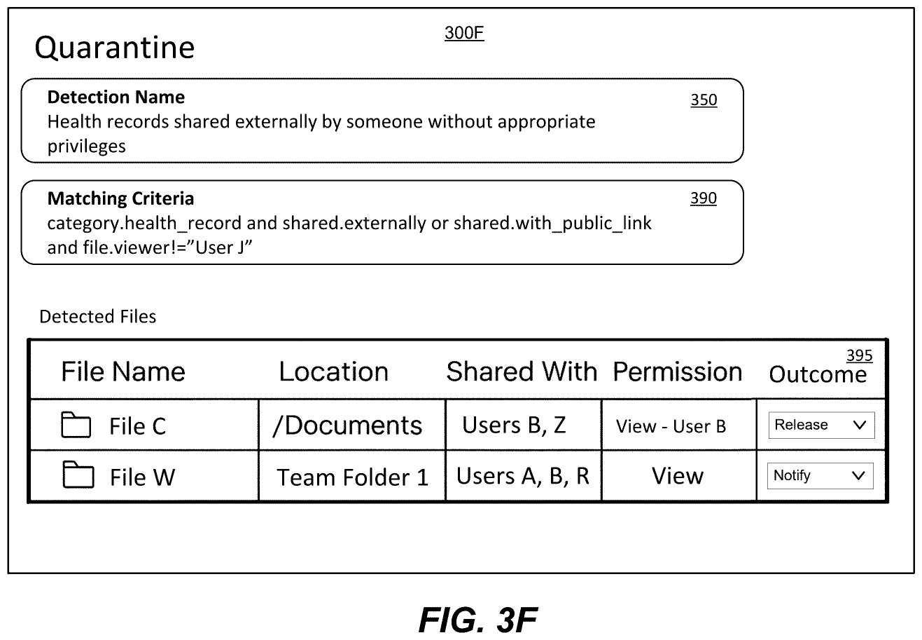

Administrator 112 may be a person having credentials to take remedial action with respect to content within domain 110, such as files, electronic communications (e.g., instant messages, emails, text messages, and any other type of electronic communication whether or not taken through a third-party application such as Slack or Teams), which are all henceforth referred to as files for simplicity. Administrator 112 may, as described with respect to FIGS. 3A-3F below, set rules to automatically detect files and set automatic remedial actions to occur with respect to those files. Administrators themselves may have their associated files subject to rules for remediation (e.g., where there is a hierarchy in the administrators and more strict rules are applied with respect to content of administrators that are lower in the hierarchy; e.g., where security rules may apply uniformly regardless of user credentials; etc.).

Network 120 may be any network suitable for interfacing user 111 and administrator 112 to domain 110 (e.g., in scenarios where users are distributed, such as working remotely or across many office sites). Network 120 may be any network suitable for interfacing domain 110 to secure communications service 130 and/or content management system 140, and for interfacing secure communications service 130 to content management system 140. Network 120 may be any data communications channel, such as any combination of the Internet, Wi-Fi, short-range links, local area networks, and so on. Network tunneling may be used to connect any entity depicted in FIG. 1, such as virtual private network (VPN) or any other tunneling protocol.

Secure communications service 130 is a cloud service provider that provides tools to domain 110 for securing domain content stored on content management system 140. Content management system 140 is a cloud service offering secure content storage for content generated and/or stored by users of domain 110. Content management system 140 may offer permission settings for content from a domain. The permission settings may enable owners and/or authors of content to establish permissions for usage of the files. The permissions may be to access, edit, share, copy, credential permissions for other users, or perform any other function with respect to a given piece of content. Usage of content management system 140 to store files of domain 110 offers security risks. For example, private content that should not be shared outside of domain 110 may accidentally be credentialed with permissions for general public access or for access by one or more external parties. Secure communications service 130 provides tools that enable administrators of domain 110 to create rules that close security gaps in files that are stored outside of domain 110 in content management system 140. While only one content management system 140 is shown in environment 100, any number of different content management systems may be used and secure communications service 130 may generate and enforce rules across those different content management systems. Further details of secure communications service 130 and content management system 140 are described below with respect to FIGS. 3A-3F.

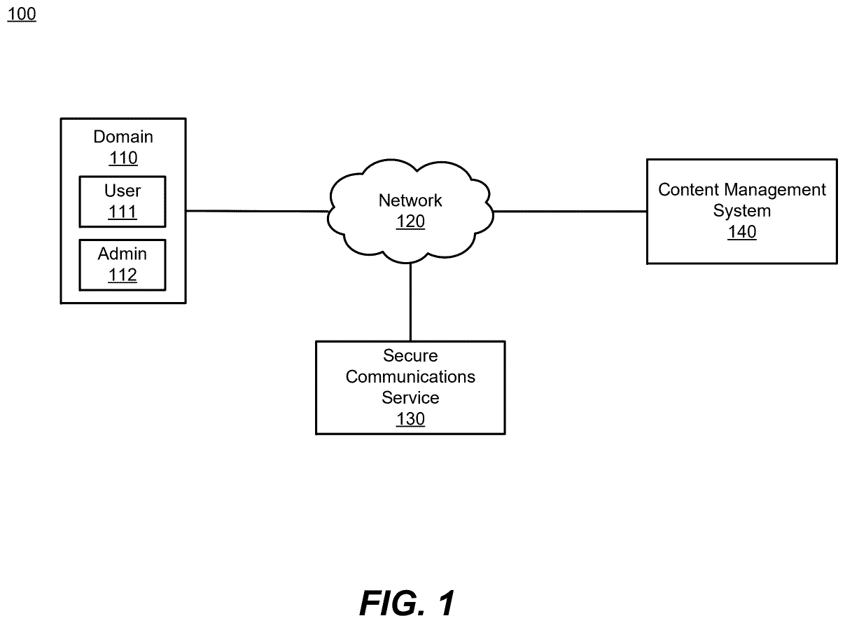

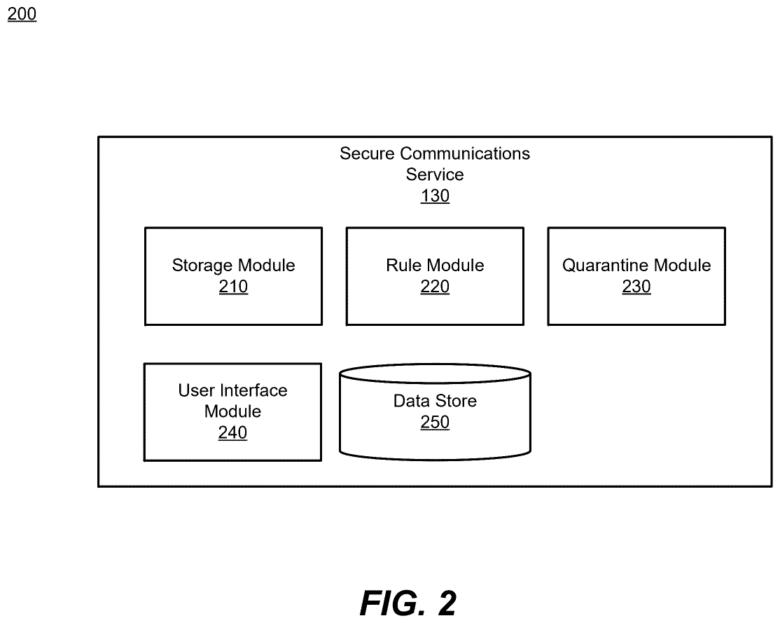

FIG. 2 is a block diagram of a secure communications service 130, in accordance with one or more embodiments. The secure communications service 130 includes storage module 210, rule module 220, quarantine module 230, user interface module 240, and data store 250. In some embodiments, additional or alternative components to those shown may be included in the secure communications service 130.

Storage module 210 stores files of domain 110 in a secure repository. Though referred to herein as files, the files may include any content able to be stored within content management system 140. The secure repository may be stored within content management system 140, on-premises within domain 110, and/or within another secure content storage database. For example, storage module 210 (or user interface module 240) may cause an application programming interface (API) to hook into domain 110 and monitor for files being written to content management system 140 that originate from domain 110. As files are written, updated, or otherwise accessed or created, storage module 210 may store a copy of some or all of the file, and may store metadata corresponding to the file to the secure repository. The metadata may indicate characteristics of the file, such as a type of file, an author and/or owner of the file, permissions for accessing or otherwise manipulating the file, a category of the file, an indication of whether or not the file is suspicious, and so on. Files stored for domain 110 may be distributed in any number of locations with permissions that prevent a search by an administrator across all files of domain 110.

Storage module 210 may also maintain a permissions data structure for files that are written, edited, or otherwise updated in content management system 140. The permissions data structure describes permissions for files with data stored in the secure repository. The permissions for a file may indicate one or more users who may access, edit, share, copy, credential permissions for other users, or perform any other function with respect to the file. Storage module 210 may determine permissions for a file based on the file's metadata and update the permissions data structure in local storage (e.g., data store 250) to correspond with the permissions described in the metadata.

As files are written or otherwise edited at the content management system 140, storage module 210 monitors the content and/or metadata of the files to detect files that satisfy one or more rules. The rules may have been previously created by the user 111 or administrator 112 and indicate characteristics of files the user 111 or administrator 112 wants to be detected by the secure communications service 130 during storage of the files at the content management system 140. The rules may be stored in data store 250. Each rule identifies a set of matching criteria and specifies a remediation action. The matching criteria includes one or more characteristics of a file described in a file's metadata. The matching criteria may be specified via input from the administrator 112 and include regular expressions, strings or phrases, Boolean operators, wildcard characters, and the like. A remediation action related to a rule may indicate what to do with a file that meets the matching criteria described by the rule. Remediation actions may include flagging the file for review, moving the file to a quarantine storage area, providing permissions to the file to one or more administrators 112, and the like. Storage module 210 sends identifiers of files with metadata meeting the matching criteria to quarantine module 230, along with an identifier of the rule associated with the matching criteria.

Storage module 210 may receive requests to search for files from user interface module 240. A request may indicate matching criteria for the files to be searched. Storage module 210 searches the secure repository for files that fit matching criteria in response to receiving a request. Storage module 210 may access all or portions of each file or metadata corresponding to each file when searching within the secure repository and compares the matching criteria to the accessed information to select files that meet the matching criteria. Storage module 210 sends metadata describing each file that corresponds to the matching criteria to the user interface module 240.

Rule module 220 receives requests to create rules for monitoring files. Rule module 220 may receive the requests from user interface module 240, and each request may include matching criteria to be used as a rule and a remediation action to take with respect to files that meet the matching criteria. Rule module 220 stores rules in association with identifiers in data store 250, such that the rules can be accessed by any of the modules of secure communications service 130.

Quarantine module 230 applies remediation actions for files that violated one or more rules. During the monitoring of files, storage module 230 sends identifiers of files that met matching criteria of a rule to quarantine module 230, which handles application of one or more remediation actions for each file. The remediation actions may include flagging the file for review or quarantining the file. For each file, quarantine module 230 may access the file or metadata associated with the file from the secure repository. Quarantine module 230 may also receive an identifier of a rule that includes matching criteria that the file met and access the rule in data store 250 to retrieve a remediation action associated with the rule. In some embodiments, a rule may be associated with two or more remediation actions.

Quarantine module 230 may perform the remediation action associated with the rule. In some embodiments, quarantine module 230 performs actions based on requests to perform the remediation actions from user interface module 240. For a remediation action that indicates to flag the file for review, quarantine module 230 may store the identifier of the file and identifier of the rule in a review data structure in data store 250. Quarantine module 230 may send an indication to user interface module 240 for each file that is flagged for review or, when one or more files are currently stored in the review data structure, may periodically send indications to user interface module 240 indicating that one or more files need review.

For a remediation action to quarantine a file, quarantine module 230 may quarantine the file by manipulating the permissions associated with the file and moving the file to a quarantine storage area. Because the file is stored in cloud storage at content management system 140, quarantine module 230 must alter of permissions of the file in a structured fashion to prevent the spread of access to the file across the domain 110. In contrast, files stored within a localized content management system, like an inbox for email, are not at risk of being shared externally upon quarantine.

Quarantine module 230 maintains the quarantine storage area for domain 110 to move files to for quarantine. The quarantine storage area may be an area that is only credentialed to be accessed by one or more administrators 112 of domain 110. Before the file can be moved to the quarantine storage area, quarantine module 230 may provide direct permission to the file to one or more administrators 112. Direct permission allows an administrator allocated the direct permission to access and manipulate the file. Quarantine module 230 allocates direct permission to the administrator(s) 112 before revoking permissions of other users to ensure that the administrator(s) 112 has access to the file upon quarantine. Quarantine module 230 may allocate direct permission to each administrator by updating the permissions data structure of the data store 250 to indicate that the administrator has permissions to access and manipulate the file.

After one or more administrators are added to the file, quarantine module 230 may revoke permissions for all other users that have permission to access the file. For instance, quarantine module 230 may determine a set of users associated with the file in the permissions data structure. Quarantine module 230 segments the set of users into a first set of users and a second set of users. Users in the first set may have access to a storage location that the file is in, which gives these users inherited permissions to access the file. Quarantine module 230 updates the permissions data structure of data store 250 to revoke existing direct permissions to access the file for users in the second set of users and maintains the inherited permissions to the file in the permissions data structure for the first set of users. Quarantine module 230 revokes the direct permissions before moving the file to the quarantine storage area so that the users in the second set who had direct permission cannot access the file while the file is within the quarantine storage area.

In response to users in the second set, if any, having their direct permissions revoked, quarantine module 230 moves the file to the quarantine storage area from the storage location. Quarantine module 230 then removes inherited permissions to access the file from the first set of users, given that the file is located in the quarantine storage area and not the previous storage location. Quarantine module 230 stores identifiers of each user that had permissions revoked in association with an identifier of the file and a type of permission the user had (e.g., direct or inherited) in a registry of revoked users within data store 250. Quarantine module 230 may also store an indication of the previous storage location in association with an identifier of the file in the registry. Quarantine module 230 may access the registry to reallocate permissions to users in response to the file being released from the quarantine storage area and moved back to its original storage location.

Quarantine module 230 may receive requests from user interface module 240 to remove files from the quarantine storage area. A request may include an identifier of the file, and quarantine module 230 may use the identifier to access the previous location of the file and users who had permissions revoked from the file in the registry stored at data store 250. Quarantine module 230 moves the file back to the previous storage location and, subsequently, reinstates the inherited permissions of the users in the first set by updating the permissions data structure. Quarantine module 230 further updates the permissions data structure to reinstate direct permissions to access the file for users in the second set of users.

User interface module 240 generates user interfaces for display to users 111 and administrators 112 in the domain 110. User interface module 240 may generate an interface that allow users to search amongst files with metadata stored in the secure repository. Though the following description pertains to interactions by an administrator 112 with one or more interfaces, in some embodiments, a user 111 may perform the same interactions. The user interface module 240 may generate the interface in response to receiving a request from an administrator 112 to perform a search. In some embodiments, the matching criteria is entered as part of a query or search string. The interface may include one or more interactive elements configured to receive matching criteria input by the administrator 112. User interface module 240 may sends a request to search for files based on the matching criteria to storage module 210.

User interface module 240 may also generate a set of suggested queries to present via the interfaces. User interface module 240 may access historical data describing previous matching criteria requested by the administrator 112 from data store 250. In some embodiments, the historical data also describes with interactions of the administrator 112 with the content management system 140. In some embodiments, the historical data describes matching criteria and interactions of all administrators 112 and users 111 of the domain 110. User interface module 240 may input the historical data to a machine learning model and receives one or more suggested queries from the machine learning model. User interface module 240 includes the suggested queries in the interface, such that the administrator may select a suggested query to send in a request to search for files to storage module 210.

User interface module 240 (or another module of secure communications service 130) may train machine learning model on historical data labeled with a set of matching criteria entered by the administrator 112. For example, the machine learning model may be trained based on prior behavior of the administrator, a team of administrators, or general preferences of the domain. In some embodiments, the machine learning model may be trained on search strings, where each search string labeled with whether or not a rule was established by rule module 220 based on the search string. The machine learning model may be any supervised machine learning model, such as a convolutional neural network, a random forest model, and so on. The training examples may include example search strings as labeled with whether or not a security rule was established based on the example search string.

User interface module 240 receives metadata describing each file that corresponds to the matching criteria entered via the interface. User interface module 240 generates an interface identifying each file and may include metadata related to each file in the interface. For example, the interface may include an identifier of each file along with a storage location of the file, an indication of who has permission to access or manipulate the file, analysis for content contained with the file, and the like. User interface module 240 may update the interface as the administrator 112 inputs additional matching criteria. User interface module 240 may receive an indication to save matching criteria as a rule via the interface and sends a request to create a rule with the matching criteria to rule module 220. In some embodiments, user interface module 240 may receive an indication to quarantine one of the files and sends a request to quarantine module 230 to move the file to the quarantine storage area.

User interface module 240 may generate interfaces identifying files that have been flagged for review and interfaces identifying files in the quarantine storage area. User interface module 240 may do so in response to receiving a request from the administrator 112 to view the flagged files or quarantine storage area. In some embodiments, user interface module 240 may may cause an interface currently being display to the administrator 112 to depict an alert in response to receiving an indication that one or more files need review (e.g., were flagged) or were quarantined from quarantine module 230. The interfaces may include an identifier of each file and metadata related to each file. For the flagged files, the interfaces may include one or more interactive elements that the administrator 112 may interact with to indicate that the file has been reviewed. For the quarantine storage area, the interfaces may include one or more interactive elements that allow the administrator to access or otherwise manipulate the files that are within the quarantine storage area. The administrator may also interact with the interfaces to select one or more files to remove from the quarantine storage area, which causes user interface module 240 to sends a request to quarantine module 230 to remove the one or more files from the quarantine storage area.

FIGS. 3A-3F illustrate exemplary user interfaces that are used by administrators operating a secure communications service to secure cloud-stored files of a domain. As depicted in FIG. 3A, user interface 300A includes search interface 310 and suggested queries 320. User interface 300A is generated by secure communications service 130 for display to an administrator 112 and includes suggest queries that a user can select. User interface 300A receives search queries through search interface 310, and secure communications service 130 performs searches on files of domain 110 responsive to receiving the search queries.

As shown in FIG. 3B, administrator 112 input a search string to search interface 310. The search string describes health records that are shared externally, or any file that is shared with a public link. This may be counter to the intent of the administrator 112, where the administrator 112 intended to only search for health records, and meant for health records that are shared with a public link to be within the scope of the search rather than any file at all. Search results 330 are populated by secure communications service 130 searching the secure repository, and the search results 330 show various results, including someone's expired passport, a document with a social security number, and a health record.

Turning to FIG. 3C, administrator 112 adjusts the search string in search interface 310 to use parentheses to clarify to only search for health records. Updated search results 331 show health records that match the adjusted search string after an updated search is performed by secure communications service 130. However, administrator 112 may notice that some of the health records stored are being shared by a user, User J, who is authorized to perform such shares. Turning to FIG. 3D, the search string is again updated to exclude this user, and further updated search results 332 are yielded after an updated search is performed by secure communications service 130, the further updated search results showing publicly accessible health records shared by unauthorized users.

At this point, administrator 112 may take manual action to perform a remedial function for files of search results 332, such as revoking the public permissions on those files, alerting the author, and so on. Alternatively or additionally, administrator 112 may establish the search string shown in search interface 310 as a rule for detecting files having the specified quality, and may establish rules for what happens when the specified quality is detected. User interface 300D may have a selectable option 340 for saving the search string as a new detection. Responsive to receiving a selection of selectable option 340, secure communications service 130 may save the search string as a rule and may detect, as files of domain 110 are updated, stored, or generated, whether those files match the rule.

Turning to FIG. 3E, user interface 300E may enable administrator 112 to save a name 350 for the rule, which will be saved in association with the rule for retrieval at a later date to ease administrator 112 in finding, deleting, and/or otherwise modifying the rule. User interface 300E may also include selectable option 360 for enabling or disabling the rule for detections at any time. User interface 300E includes remediation option 370 for enabling or disabling automatic remediation for files detected that match a detection rule. Any number of automatic remediation options 380 may be enabled, such as notifying an owner of the file, quarantining the file, or any other remediation activity. Where remediation is not enabled, an alert may be provided to administrator 112 who may manually instruct to take remedial action (or not).

Turning to FIG. 3F, user interface 300F may enable an administrator 112 to view one or more files that have been quarantined. The user interface 300F may also include a name 350 a name of a rule and associated matching criteria 390 that the files met in order to be quarantined. In some embodiments, the user interface 300F may include multiple rules and matching criteria 390. The user interface 300F may present metadata related to each file and include one or more interactive elements that allow the administrator to select an outcome 395 for each file. For example, the user interface 300F may include drop-down menus that allow the administrator to select whether to release (e.g., remove) the file from quarantine or to notify one or more users 111 that previously had permissions for the file that the file was quarantined. User interface module 240 may send an indication to quarantine module 230 to release a file in response to receiving a corresponding interaction via the user interface 300F, which may lead to reinstating permissions for the file that existed prior to quarantine.

### Computing Machine Architecture

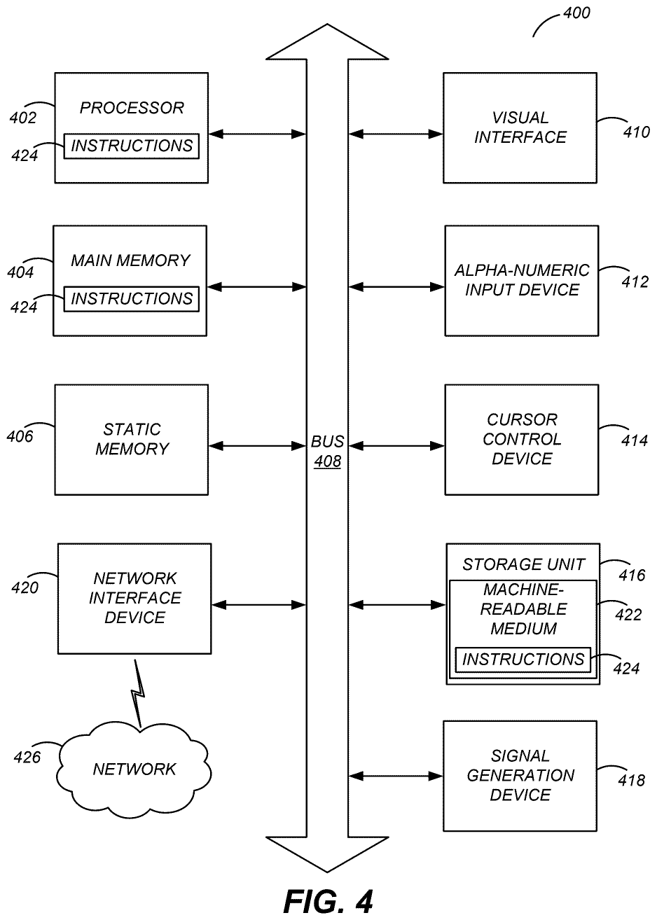

FIG. (Figure) 4 is a block diagram illustrating components of an example machine able to read instructions from a machine-readable medium and execute them in a processor (or controller, or one or more of the same). Specifically, FIG. 4 shows a diagrammatic representation of a machine in the example form of a computer system 400 within which program code (e.g., software, including the modules described herein) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Example Methods

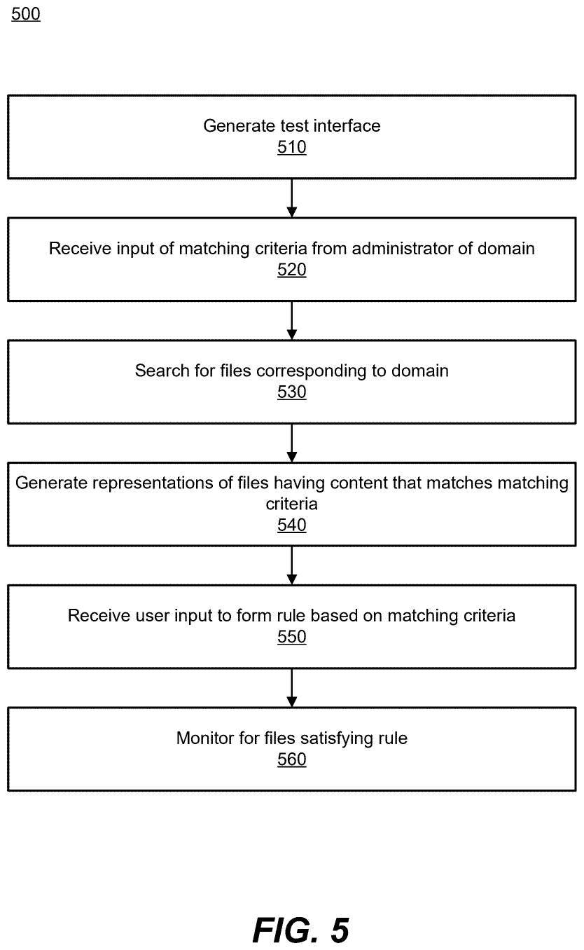

FIG. 5 is a flowchart of a method for monitoring for files that satisfy a rule, in accordance with one or more embodiments. In some embodiments, additional or alternative steps or components to those described may be used to perform the method 500. Further, the components described may be executed by the computer system 400 described in relation to FIG. 4.

The method 500 begins with user interface module 240 generating 510 for display a test interface including an input field for matching criteria. User interface module 240 receives 520 an input of matching criteria from an administrator of a domain via the input field. User interface module 240 sends the matching criteria to storage module 210, and storage module 210 searches 530 for files within a content management system repository corresponding to the domain having content that matches the matching criteria. Storage module 210 sends the files to user interface module 240, and user interface module 240 generates 540, for display, a test interface with representations (e.g., identifiers and/or metadata) of the files within the content management system repository corresponding to the domain having content that matches the matching criteria. User interface module 240 updates the representations as the matching criteria is edited. User interface module 240 receives 550 user input to form a rule based on the matching criteria and sends the matching criteria to rule module 220. Storage module 210 monitors 560 for files satisfying the rule, such that the detection of files satisfying the rule cause a remediation action to be performed.

In some embodiments, the test interface includes an application programming interface (API) that hooks into the domain 110 and monitors for files being written to the content management system that originate from the domain 110. The API may be created and controlled by storage module 210. Storage module 210 may capture, via the webhook, a first file recently added at the domain and determine whether the first file contains content that matches the matching criteria of the rule. In response to determining that the first file contains content that matches the matching criteria of the rule, storage module 210 causes quarantine module 230 performing the remediation action.

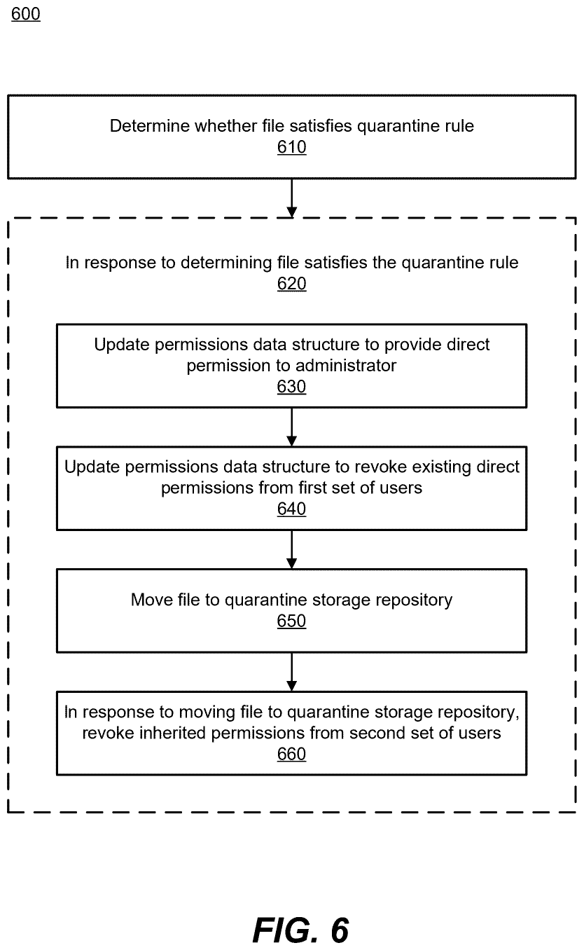

FIG. 6 is a flowchart of a method for quarantining a file, in accordance with one or more embodiments. In some embodiments, additional or alternative steps or components to those described may be used to perform the method 600. Further, the components described may be executed by the computer system 400 described in relation to FIG. 4.

The method 600 begins with storage module 210 determining 610 whether a file stored in cloud storage in association with a domain 110 satisfies a quarantine rule (e.g., a rule associated with a remediation action for quarantining the associated file). Storage module 210 makes the determination based on metadata associated with the file that is stored in a content management system repository corresponding to the domain 110. In response 620 to determining that the file that satisfies the quarantine rule, storage module 210 sends the file to quarantine module 230. Quarantine module 230 updates 630 a permissions data structure to provide direct permission to an administrator 112 to access the file. The administrator has access to files stored within a quarantine storage repository for the domain 110. Quarantine module 230 updates 640 the permissions data structure to revoke existing direct permission to access the file for a first set of users. A second set of users retain inherited permission to access the file based on being permissioned to access one or more files (including the file) in a given cloud storage location, whereas the first set of users do not. Quarantine module 230 moves 650 the file to the quarantine storage repository. In response moving the file to the quarantine storage repository, quarantine module 230 revokes 660 the inherited permissions to access the file from each of the second set of users.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for enforcing security in cloud-stored files for a domain through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for identifying security vulnerabilities, the method comprising:
generating for display a test interface including an input field for matching criteria;
receiving input of matching criteria from an administrator of a domain;
searching for files within a content management system repository corresponding to the domain;
generating for display representations of files within the content management system repository corresponding to the domain having content that matches the matching criteria, wherein the representations are updated as the matching criteria is edited;
receiving user input to form a rule based on the matching criteria; and
monitoring for files satisfying the rule, the monitoring resulting in a remediation action for files satisfying the rule.

2. The method of claim 1, wherein the content management system is a cloud service that stores content at an electronic repository for users of the domain.

3. The method of claim 1, the method further comprising:
capturing, via a webhook, a first file recently added at the domain;
determining whether the first file contains content that matches the matching criteria of the rule; and
in response to determining that the first file contains content that matches the matching criteria of the rule, performing the remediation action.

4. The method of claim 3, wherein the matching criteria indicates to detect content with corresponding metadata including an indication that the content is suspicious, and wherein performing the remediation action comprises:
allocating direct permission to access a first file to a first user of the domain;
revoking direction permission to access the first file from a second user of the domain; and
moving the first file to a quarantine storage area, wherein the first user has access to the quarantine storage area.

5. The method of claim 1, wherein the remediation action comprises quarantining files that satisfy the rule, the method further comprising:
determining in response to receiving, for a first file in a quarantine storage area, an indication from the administrator to remove the first file from the quarantine storage area:
moving the first file from the quarantine storage area to a first folder of the content management system repository, wherein moving the first file to the content management system repository causes inherited permissions associated with the first folder to be provided for the first file.

6. The method of claim 1, further comprising:
generating recommendations for matching criteria using a machine learning model trained to output recommendations based on prior searches performed by at least one client device associated with an administrator.

7. The method of claim 6, wherein the machine learning model is trained on search strings, each search string labeled with whether or not a security rule was established based on the search string.

8. A non-transitory computer-readable storage medium storing instructions that, when executed, cause a processor to perform one or more steps comprising:
generating for display a test interface including an input field for matching criteria;
receiving input of matching criteria from an administrator of a domain;
searching for files within a content management system repository corresponding to the domain;
generating for display representations of files within the content management system repository corresponding to the domain having content that matches the matching criteria, wherein the representations are updated as the matching criteria is edited;
receiving user input to form a rule based on the matching criteria; and
monitoring for files satisfying the rule, the monitoring resulting in a remediation action for files satisfying the rule.

9. The non-transitory computer-readable storage medium of claim 8, wherein the content management system is a cloud service that stores content at an electronic repository for users of the domain.

10. The non-transitory computer-readable storage medium of claim 8, the steps further comprising:
capturing, via a webhook, a first file recently added at the domain;
determining whether the first file contains content that matches the matching criteria of the rule; and
in response to determining that the first file contains content that matches the matching criteria of the rule, performing the remediation action.

11. The non-transitory computer-readable storage medium of claim 10, wherein the matching criteria indicates to detect content with corresponding metadata including an indication that the content is suspicious, and wherein performing the remediation action comprises:
allocating direct permission to access a first file to a first user of the domain;
revoking direction permission to access the first file from a second user of the domain; and
moving the first file to a quarantine storage area, wherein the first user has access to the quarantine storage area.

12. The non-transitory computer-readable storage medium of claim 8, wherein the remediation action comprises quarantining files that satisfy the rule, the steps further comprising:
determining in response to receiving, for a first file in a quarantine storage area, an indication from the administrator to remove the first file from the quarantine storage area:
moving the first file from the quarantine storage area to a first folder of the content management system repository, wherein moving the first file to the content management system repository causes inherited permissions associated with the first folder to be provided for the first file.

13. The non-transitory computer-readable storage medium of claim 8, the steps further comprising:
generating recommendations for matching criteria using a machine learning model trained to output recommendations based on prior searches performed by at least one client device associated with an administrator.

14. The non-transitory computer-readable storage medium of claim 13, wherein the machine learning model is trained on search strings, each search string labeled with whether or not a security rule was established based on the search string.

15. A system comprising:
a processor; and
a non-transitory computer-readable storage medium storing instructions that, when executed, cause the processor to perform one or more steps comprising:
generating for display a test interface including an input field for matching criteria;
receiving input of matching criteria from an administrator of a domain;
searching for files within a content management system repository corresponding to the domain;
generating for display representations of files within the content management system repository corresponding to the domain having content that matches the matching criteria, wherein the representations are updated as the matching criteria is edited;
receiving user input to form a rule based on the matching criteria; and
monitoring for files satisfying the rule, the monitoring resulting in a remediation action for files satisfying the rule.

16. The system of claim 15, wherein the content management system is a cloud service that stores content at an electronic repository for users of the domain.

17. The system of claim 15, the steps further comprising:
capturing, via a webhook, a first file recently added at the domain;
determining whether the first file contains content that matches the matching criteria of the rule; and
in response to determining that the first file contains content that matches the matching criteria of the rule, performing the remediation action.

18. The system of claim 15, wherein the remediation action comprises quarantining files that satisfy the rule, the steps further comprising:
determining in response to receiving, for a first file in a quarantine storage area, an indication from the administrator to remove the first file from the quarantine storage area:
moving the first file from the quarantine storage area to a first folder of the content management system repository, wherein moving the first file to the content management system repository causes inherited permissions associated with the first folder to be provided for the first file.

19. The system of claim 15, the steps further comprising:
generating recommendations for matching criteria using a machine learning model trained to output recommendations based on prior searches performed by at least one client device associated with an administrator.

20. The system of claim 19, wherein the machine learning model is trained on search strings, each search string labeled with whether or not a security rule was established based on the search string.
